(19) United States
(12) Patent Application Publication
(10) Pub. No.: US 2020/0070991 A1
(43) Pub. Date: Mar. 5, 2020

(54) NACELLE FOR AN AIRCRAFT ENGINE INCLUDING MEANS PREVENTING THE DEFORMATION OF THE ARTICULATED FAN COVERS

(71) Applicant: Airbus Operations SAS, Toulouse (FR)

(72) Inventors: Alain PORTE, Colomiers (FR); Grégory ALBET, Grepiac (FR); Julien SENTIER, Colomiers (FR)

(21) Appl. No.: 16/558,704

(22) Filed: Sep. 3, 2019

(30) Foreign Application Priority Data
Sep. 5, 2018 (FR) 1857959

(51) Int. Cl. B64D 29/00; F02C 7/04

(52) U.S. Cl. CPC B64D 29/00; F05D 2240/14; F02C 7/04

(57) ABSTRACT

A nacelle including a fixed structure, a central cover mounted on the fixed structure, a fan cover mounted on and articulated to the central cover between an open position and a closed position, and locking means that are distributed between each fan cover and the fixed structure and that are designed to assume a locked position in which they lock the fan cover to the fixed structure and an unlocked position in which they do not lock the fan cover to the fixed structure, in which the locked position can be adopted only when the fan cover is in the closed position, and in which the unlocked position can be adopted whether the fan cover is in the open or closed position and wherein the locking means are locked and unlocked by a rotation around a longitudinal axis of the nacelle.

### CROSS-REFERENCES TO RELATED APPLICATIONS

This application claims priority from French Patent Application No. 1857959 filed Sep. 5, 2018, the entirety of which is incorporated herein by reference.

### FIELD OF THE INVENTION

The present invention concerns a nacelle for an aircraft engine when the nacelle includes means for preventing deformation of the articulated fan covers and a propulsion system including an aircraft engine and a nacelle of this kind as well as an aircraft including at least one such propulsion system.

### BACKGROUND OF THE INVENTION

A nacelle of an aircraft engine constitutes the exterior skin of the engine and forms an aerodynamic surface which assures a good flow of air around the engine.

FIG. 6 shows a front half-view of a prior art nacelle 60. The nacelle 60 includes a fan cover 62 that is disposed around the fan cowling and the fan 64 of an aircraft engine.

The fan cover 62 is mounted on and articulated to a fixed structure 66 of the nacelle 60 or of the pylon by means of articulations 68. The articulations 68 are disposed in the upper part and enable the fan cover 62 to be opened during maintenance inspections. The fan cover 62 is locked in the lower part by a lock 70 when it is closed.

The fan cover 62 is therefore fixed only in the upper part and in the lower part. Because of the conjugate action of deformation of the engine and deformations caused by aerodynamic stresses, the fan cover 62 would tend to be deformed which would lead to the occurrence of a scooping phenomenon.

The reference 72 shows the deformation of the fan cover 62 in dashed outline.

To prevent the appearance of these deformations, the structure of the fan cover 62 is reinforced, which at the same time adds to the weight of the fan cover 62.

### SUMMARY OF THE INVENTION

An object of the present invention is to propose a nacelle for an aircraft engine where the nacelle includes means for preventing deformation of the articulated fan covers.

To this end there is proposed a nacelle for an aircraft engine, said nacelle including:
a fixed structure,
a central cover mounted on the fixed structure,
at least one fan cover mounted on and articulated to the central cover between an open position and a closed position, and
locking means that are distributed between each fan cover and the fixed structure and that are designed to assume a locked position in which they lock the fan cover to the fixed structure and an unlocked position in which they do not lock the fan cover to the fixed structure, wherein the locking means are locked and unlocked by a rotation around a longitudinal axis of the nacelle.

The locking means therefore prevent deformation of the fan covers in flight.

According to one particular embodiment, the locking means include:
a rail,
a plurality of guides each fastened to the fixed structure and having a through-orifice for the rail to pass through,
a plurality of male or female elements each fastened to the rail and having an axis globally parallel to the direction of the tangent to the rail at the fixing point of said element,
for each male or female element, a shoe fastened to a fan cover and having a female element or a male element which in the closed and locked position is coaxial with said male element or female element, and
an activation system designed to move the rail from the unlocking position in which none of the male elements is introduced into a female element to the locked position in which each male element is introduced into a female element, and vice versa.

According to one particular embodiment, the fixed structure includes at least one guide rail, the central cover includes, for each guide rail, a slider that is designed to be moved in translation relative to said guide rail and the locking means include:
a plurality of male or female elements, each being fastened to the fan cover and having an axis globally parallel to the direction of the tangent to the fan cover at the fixing point of said element,
for each male or female element, a female or male element, in which each is fastened to the fixed structure and which in the closed and locked position is coaxial with said male or female element, and
an activation system designed to move the central cover and the fan covers from the unlocked position in which none of the male elements is introduced into a female element to the locked position in which each male element is introduced into a female element, and vice versa.

The invention also proposes a propulsion system including an engine and a nacelle according to any one of the foregoing variants.

The invention also proposes an aircraft including a propulsion system according to the preceding claim.

### BRIEF DESCRIPTION OF THE DRAWINGS

The features of the invention referred to hereinabove and others will become more clearly apparent on reading the following description of one embodiment, said description being given with reference to the appended drawings, in which:

FIG. 1 is a side view of an aircraft according to the invention,

FIG. 2 is a partial front perspective view of a nacelle according to a first embodiment of the invention,

FIG. 3 is a partial perspective view of the nacelle from FIG. 2,

FIG. 4 is a view in the direction of the arrow IV in FIG. 3,

FIG. 5 is a perspective view of a nacelle according to a second embodiment of the invention, and

FIG. 6 is a front view of a prior art nacelle.

### DETAILED DESCRIPTION OF EMBODIMENTS

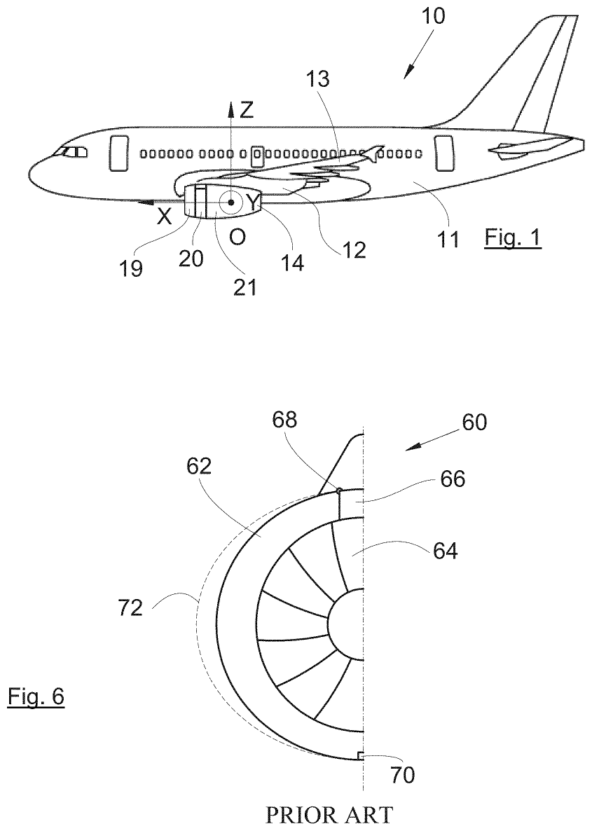

In the following description, terms relating to a position are referred to an aircraft in the position of forward movement, that is to say as represented in FIG. 1.

FIG. 1 shows an aircraft 10 that includes a fuselage 11 to each side of which it is fixed a wing 13. Under each wing 13 is fixed at least one pylon 12 that supports an engine that is surrounded by a nacelle 14 that includes an air intake 19 at the front, fan covers 20 behind the air intake 19 and a rear part 21 behind the fan covers 20 that includes among other things the thrust reversing system. The engine and the nacelle 14 that surrounds it form a propulsion system in accordance with the invention.

Throughout the following description, by convention, the direction X corresponds to the longitudinal direction of the engine, that direction being parallel to the longitudinal axis X of the nacelle. Also, the direction Y corresponds to the direction oriented transversely relative to the engine, and the direction Z corresponds to the vertical or heightwise direction, these three directions X, Y, Z being mutually orthogonal.

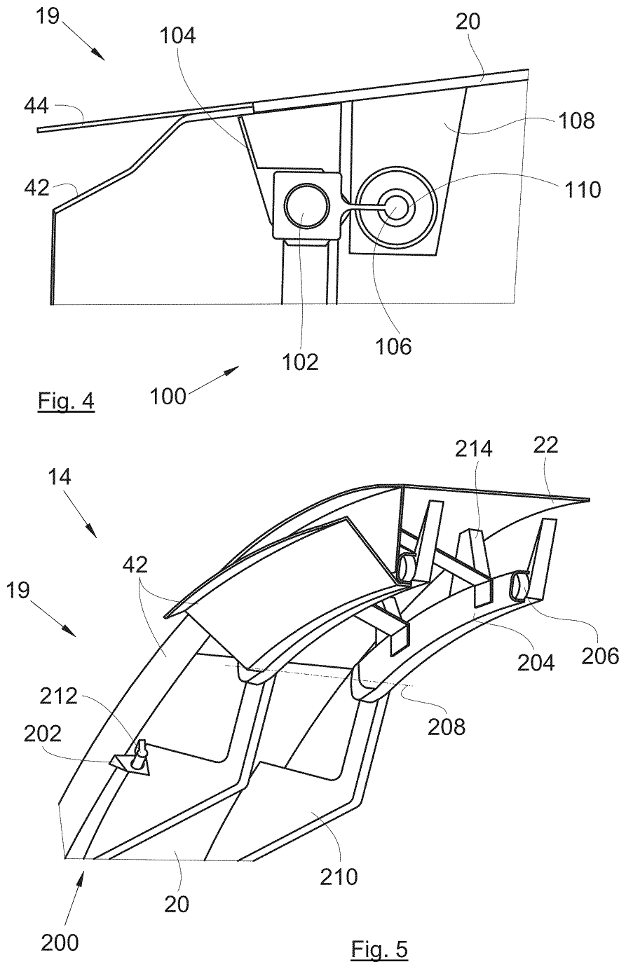

The air intake 19 includes a fixed structure (42, FIG. 4) and an exterior skin (44, FIG. 4) fixed to the fixed structure 42.

The nacelle 14 includes a central cover 22 that is disposed on each side of a vertical median plane passing through the longitudinal axis X. The central cover 22 is mounted on the fixed structure 42 of the air intake 19 either in a fixed manner in the first embodiment of the invention or in a mobile manner in the second embodiment of the invention.

The fan covers 20 are mounted on and articulated to the central cover 22.

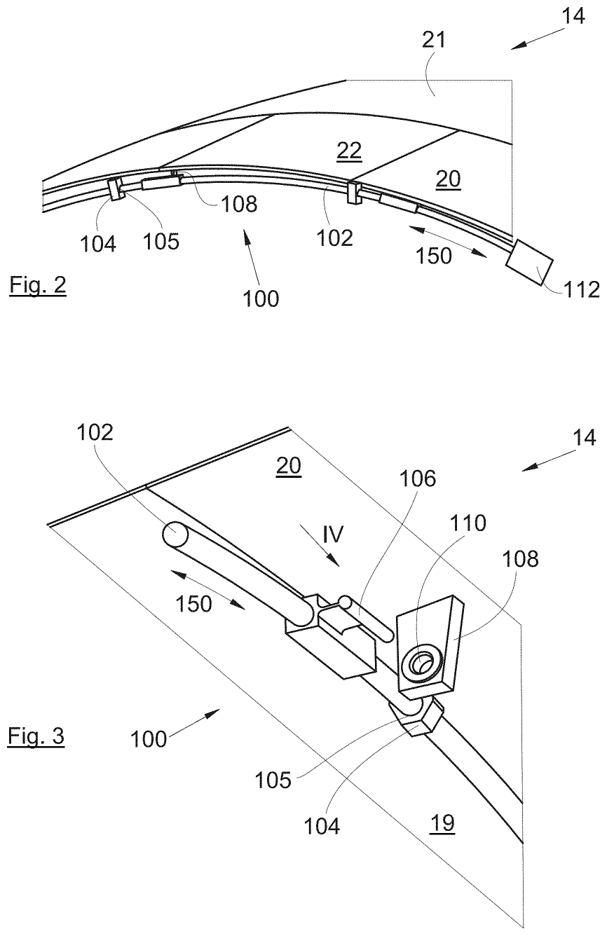

FIG. 2 shows the nacelle 14 according to a first embodiment of the invention without the air intake 19. FIG. 3 and FIG. 4 show the nacelle 14 according to the first embodiment of the invention and FIG. 5 shows the nacelle 14 according to a second embodiment of the invention.

The nacelle 14 includes two fan covers 20 arranged on either side of the central cover 22. Thus each fan cover 20 is mounted on and articulated to the central cover 22 between an open position and a closed position. In the closed position the fan cover 20 is folded down to be continuous with the exterior skin 44 of the air intake 19 and in the open position the fan cover 20 is moved away to provide access under the fan cover 20. Although the invention is described here in the case of two fan covers 20, it applies in the same manner as soon as there is at least one fan cover 20. Each fan cover 20 is mounted to pivot about a hinge axis globally parallel to the longitudinal axis X.

The nacelle 14 includes locking means 100, 200 that are divided between each fan cover 20 and the fixed structure 42 of the air intake 19 and are designed to assume a locked position in which they lock the fan cover 20 to the fixed structure 42 and an unlocked position in which they do not lock the fan cover 20 to the fixed structure 42.

In the locked position, the locking means 100, 200 secure the fan cover 20 to the fixed structure 42 of the air intake 19, preventing its deformation, and in the unlocked position the locking means 100, 200 do not secure the fan cover 20 to the fixed structure 42, thereby allowing opening of the fan cover 20.

The locked position can be assumed only when the fan cover 20 is in the closed position and the unlocked position can be assumed whether the fan cover 20 is in the open or closed position.

The difference between the first embodiment and the second embodiment is linked among other things to the locking means 100, 200 which are different and which are locked and unlocked by a rotation around the longitudinal axis of the nacelle 14, corresponding to a tangential movement relative to a circle centred on said longitudinal axis of the nacelle 14.

FIG. 3 shows the nacelle 14 seen from the inside in the unlocked position of the locking means 100.

In the first embodiment of the invention, the central cover 22 is fixed to the fixed structure 42 of the air intake 19 or to the pylon 12.

In the first embodiment of the invention the locking means 100 include:
a rail 102,
a plurality of guides 104 each fastened to the fixed structure 42 of the air intake 19 and including a through-orifice 105 enabling the rail 102 to pass through it, the rail 102 sliding relative to each guide 104,
a plurality of male elements 106 each fastened to the rail 102 and having an axis globally parallel to the direction of the tangent to the rail at the fixing point of the male element 106,
for each male element 106 a shoe 108 fastened to a fan cover 20 and including a female element 110 which in the closed and locked position is coaxial with the male element 106, and
an activation system 112 designed to move the rail 102 from the unlocked position in which none of the male elements is introduced into a female element to the locked position in which each male element is introduced into a female element, and vice versa.

The overall movement of the rail 102 is a rotation about the longitudinal axis X. The rail 102 has an arcuate shape and it may be circular for example or have a particular shape enabling optimum following of the interior shape of the fan cover 20.

Accordingly, as a function of the direction of movement of the rail 102 in the guides 104 (double-headed arrow 150), the male elements 106 will penetrate into the female elements 110 or exit them, thus making it possible to go from the locked position to the unlocked position.

Of course it is possible to interchange the male function and the female function between the rail 102 and the shoes 108. Each male element 106 is then replaced by a female element and each female element 110 by a male element.

The activation system 112 is for example a motor, an actuator of the cylinder type or a manual system.

In the first embodiment of the invention there is a single rail 102 for the two fan covers 20 but it is possible to provide one rail for each fan cover 20. In the case of one rail 102, the latter takes the overall form of a circle, and in the case of two rails each then assumes the overall shape of a semi-circle. Of course shapes closer to the interior shape of the fan cover 20 are possible.

There is a plurality of male elements 106 and shoes 108 disposed circumferentially around the longitudinal axis X and along the fan covers 20 for optimum retention of said fan covers 20 relative to the fixed structure 42 of the air intake 19. There are for example about twenty of these elements for each fan cover 20.

FIG. 5 shows the second embodiment of the invention in which the central cover 22 is now mobile in rotation.

The fixed structure 42 of the air intake 19 is fixed under the exterior skin 44 and globally espouses its shape. The fixed structure 42 is fixed for example to a rear frame.

The fixed structure 42 includes at least one guide rail 204, here two of them, each of which takes the form of an arc concentric with the central cover 22.

According to one particular embodiment each guide rail 204 takes the form of a circular arc concentric with the central cover 22, that is to say globally centred on the longitudinal axis X.

The central cover 22 includes for each guide rail 204 a slider 206 that is designed to be moved in translation relative to said guide rail 204. Because of the arcuate shape of each rail 204 the movement of each slider 206 is globally a rotation about the longitudinal axis X. In the embodiment of the invention from FIG. 5 the central cover 22 and the sliders 206 are fastened by means of spacers 214.

Each fan cover 20 is mounted on and articulated to the two sliders 206 about a hinge axis 208 globally parallel to the longitudinal axis X, here by means of arms 210.

The locking means 200 include:
a plurality of male elements 212 each fastened to the fan cover 20 and having an axis globally parallel to the direction of the tangent to the fan cover 20 at the fixing point of said element 212,
for each male element 212 a female element 202 with each fastened to the fixed structure 42 of the air intake 19 and in the closed and locked position coaxial with said male element 212, and
an activation system designed to move the central cover 22 and the fan covers 20 from the unlocked position in which none of the male elements is introduced into a female element to the locked position in which each male element is introduced into a female element, and vice versa.

All the male elements 212 are oriented in the same direction, which here is the anticlockwise direction.

Here the fixed structure 42 carries the female elements 202 circumferentially distributed under the exterior skin 44 around the longitudinal axis X.

Starting from the closed and locked position, that is to say when the male elements 212 are housed in the female elements 202, the male elements 212 are moved in rotation by movement, here in the clockwise direction, of the sliders 206 relative to the guide rails 204. This movement enables extraction of the male elements 212 from the female elements 202 and it is then possible to open the fan covers 20 by rotation about the hinge axis 208.

Movement in the opposite direction enables return to the closed and locked position.

In the same manner, the male function and the female function may be interchanged between the fan cover 20 and the fixed structure 42 of the air intake 19.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nacelle for an aircraft engine, said nacelle comprising:
a fixed structure,
a central cover mounted on the fixed structure,
at least one fan cover mounted on and articulated relative to the central cover between an open position and a closed position, and
locking means distributed between each fan cover and the fixed structure and configured to assume a locked position in which the locking means lock the fan cover to the fixed structure and an unlocked position in which the locking means do not lock the fan cover to the fixed structure,
wherein the locking means are locked and unlocked by a rotation around a longitudinal axis of the nacelle.

2. The nacelle according to claim 1, wherein the locking means include:
a rail,
a plurality of guides each fastened to the fixed structure and having a through-orifice for the rail to pass through,
a plurality of male elements or female elements each fastened to the rail and having an axis globally parallel to a direction of a tangent to the rail at a fixing point of said element,
for each male element or female element, a shoe fastened to the fan cover and having a complementary female element or a complementary male element which in the closed and locked position is coaxial with said male element or female element, and
an activation system designed to move the rail from the unlocking position, in which none of the male elements are introduced into a female element, to the locked position, in which each male element is introduced into a female element, and vice versa.

3. The nacelle according to claim 1, wherein the fixed structure includes at least one guide rail, and wherein the central cover includes, for each guide rail, a slider that is designed to be moved in translation relative to said guide rail and in that the locking means comprise:
a plurality of male elements or female elements, each being fastened to the fan cover and having an axis globally parallel to a direction of a tangent to the fan cover at a fixing point of said element,
for each male element or female element, a complementary female element or male element, in which each is fastened to the fixed structure and which in the closed and locked position is coaxial with said male element or female element, and
an activation system designed to move the central cover and the fan covers from the unlocked position, in which none of the male elements are introduced into a female element, to the locked position, in which each male element is introduced into a female element, and vice versa.

4. A propulsion system comprising:
an engine, and
the nacelle according to claim 1.

5. An aircraft comprising:
the propulsion system according to claim 4.
